(19) United States
(12) Patent Application Publication
(10) Pub. No.: US 2026/0135957 A1
(43) Pub. Date: May 14, 2026

(54) APPARATUS INCLUDING A PLURALITY OF HOUSINGS AND METHOD FOR MANUFACTURING THE APPARATUS

(71) Applicant: CANON KABUSHIKI KAISHA, Tokyo (JP)

(72) Inventor: TAKAYUKI HATA, Ibaraki (JP)

(21) Appl. No.: 19/344,973

(22) Filed: Sep. 30, 2025

(30) Foreign Application Priority Data
Nov. 8, 2024 (JP) 2024-196045

(51) Int. Cl. H04N 1/00

(52) U.S. Cl. CPC H04N 1/00538; H04N 1/00907; H04N 2201/0082

(57) ABSTRACT

An apparatus includes: a first housing configured to be connected to an external alternating current power source; a second housing including an electric component configured to be supplied with operation power from the first housing; a first connector; a first protective ground wire connected to the first connector and the first housing; a second connector; and a second protective ground wire connected to the second connector and the second housing, wherein the first protective ground wire and the second protective ground wire are connected by connecting the first connector and the second connector.

### BACKGROUND

### Field of the Technology

The present disclosure relates to an apparatus including a plurality of housings, and more particularly, relates to a technique of connecting housings by a protective ground wire.

### DESCRIPTION OF THE RELATED ART

In an apparatus including a plurality of housings, a configuration in which operation power is supplied from a first housing connected to an external power source to a second housing not connected to the external power source can be used. In this case, according to safety standards, it is necessary to provide double insulation or reinforced insulation in the second housing, or to provide basic insulation in the second housing, and then separately connect a protective ground wire. Providing double insulation or reinforced insulation leads to an increase in size of the apparatus. Depending on the apparatus configuration, there is also a case where it is difficult to secure an insulating distance necessary for double insulation or reinforced insulation. Japanese Patent Laid-Open No. 2007-212892 discloses the latter configuration, specifically, a configuration in which the first housing and the second housing are connected by a protective ground wire.

### SUMMARY

According to an aspect of the present disclosure, an apparatus includes: a first housing configured to be connected to an external alternating current power source; a second housing including an electric component configured to be supplied with operation power from the first housing; a first connector; a first protective ground wire connected to the first connector and the first housing; a second connector; and a second protective ground wire connected to the second connector and the second housing, wherein the first protective ground wire and the second protective ground wire are connected by connecting the first connector and the second connector.

Features of the present disclosure will become apparent from the following description of embodiments with reference to the attached drawings. The following description of embodiments are described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a cross-sectional view illustrating a schematic configuration of an image forming apparatus according to some embodiments.

FIG. 2 is a power distribution diagram of the image forming apparatus according to some embodiments.

FIGS. 3A to 3C are explanatory views of a protective ground wire according to some embodiments.

FIG. 4 is a view illustrating a state in which inter-housing bundled lines are connected by a connector according to one embodiment.

FIG. 5 is an explanatory view of processing of connecting inter-housing bundled lines by a connector according to one embodiment.

FIG. 6 is a view illustrating a comparative example in which a protective ground wire connects between two housings.

FIG. 7 is a view illustrating a state in which inter-housing bundled lines are connected by a connector according to one embodiment.

FIG. 8 is a perspective view of an image forming apparatus according to one embodiment.

FIG. 9 is a cross-sectional view illustrating a schematic configuration of the image forming apparatus according to one embodiment.

FIG. 10 is a perspective view of a sheet storing portion according to one embodiment.

FIG. 11 illustrates one part of a main body unit according to one embodiment.

FIG. 12 is a view illustrating a connector configuration of the sheet storing portion according to one embodiment.

FIG. 13 is a view illustrating a connector configuration of the main body unit according to one embodiment.

FIG. 14 is a view illustrating a state in which connectors of the sheet storing portion and the main body unit are connected according to one embodiment.

FIG. 15 is a cross-sectional view illustrating a state in which connector connection between the sheet storing portion and the main body unit is started according to one embodiment.

FIG. 16 is an explanatory view of the connectors of the sheet storing portion and the main body unit according to one embodiment.

FIG. 17 is a view illustrating a state in which connectors of two housings are connected according to one embodiment.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### First Embodiment

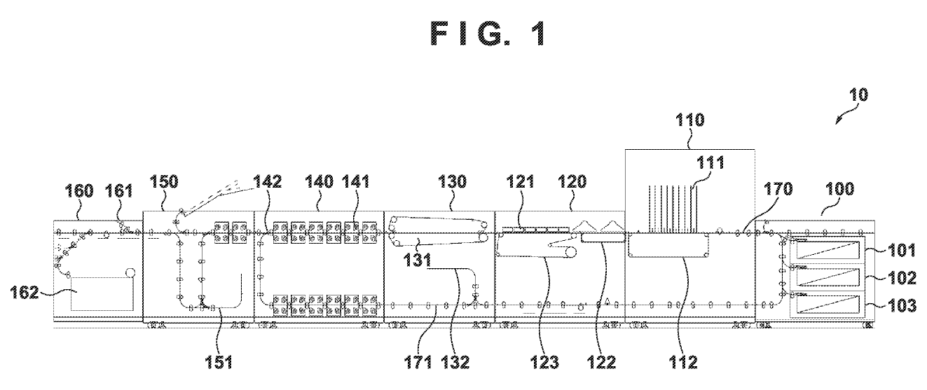

FIG. 1 is a schematic cross-sectional view of an image forming apparatus 10 of an inkjet type used for description of the present embodiment. The image forming apparatus 10 includes seven modules of a feeding module 100, a printing module 110, a drying module 120, a fixing module 130, a cooling module 140, an inverting module 150, and a stacking module 160.

The feeding module 100 includes stockers 101 to 103 that store sheets. The feeding module 100 feeds the sheets in the stockers 101 to 103 to a main conveyance path 170 of the image forming apparatus 10 and conveys the sheets to the printing module 110. The printing module 110 includes a print belt unit 112 and a recording unit 111. The recording unit 111 forms an image on a first surface of a sheet by discharging ink onto the first surface of the sheet conveyed by the print belt unit 112. The sheet on which the image is formed on the first surface is conveyed to the drying module 120.

The drying module 120 includes a decoupling unit 122, a drying belt unit 123, and a hot air blowing unit 121. The decoupling unit 122 conveys the sheet from the printing module 110 toward the drying belt unit 123. The hot air blowing unit 121 blows hot air to the sheet conveyed by the drying belt unit 123, thereby drying the sheet on which the image is formed. The sheet dried by the drying module 120 is conveyed to the fixing module 130. A fixing belt unit 131 of the fixing module 130 heats the sheet by an upper belt unit and a lower belt unit, thereby fixing the image to the sheet. The sheet on which the image is fixed is conveyed to the cooling module 140.

The cooling module 140 includes a plurality of cooling units 141. Each of the cooling units 141 cools the sheet by blowing, to the sheet, outside air taken in by a fan. When an image is formed only on one surface (the first surface) of the sheet, the sheet after cooling is conveyed to the inverting module 150 via a path switching unit 142. When images are formed on both surfaces (the first surface and a second surface) of the sheet, the sheet is conveyed to a both-surface conveyance path 171 via the path switching unit 142. The path switching unit 142 is a guide member that guides the sheet to the inverting module 150 or the both-surface conveyance path 171. The sheet conveyed to the both-surface conveyance path 171 is once conveyed to an inversion conveyance path 132 provided at the fixing module 130, and then conveyed to the main conveyance path 170 to perform image formation onto the second surface. The inversion conveyance path 132 is provided so that the second surface of the sheet conveyed to the main conveyance path 170 via the both-surface conveyance path 171 faces the side of the recording unit 111.

The inverting module 150 includes an inversion unit 151. The inversion unit 151 is used when an orientation (upward or downward in the drawing) of the first surface of the sheet having been conveyed from the cooling module 140 is inverted and conveyed to the stacking module 160. The sheet passed through the inverting module 150 is conveyed to the stacking module 160. The stacking module 160 includes a top tray 161 and a stacking unit 162. The stacking module 160 discharges, to the top tray 161, the sheet having been conveyed from the inverting module 150, or stacks the sheet onto the stacking unit 162.

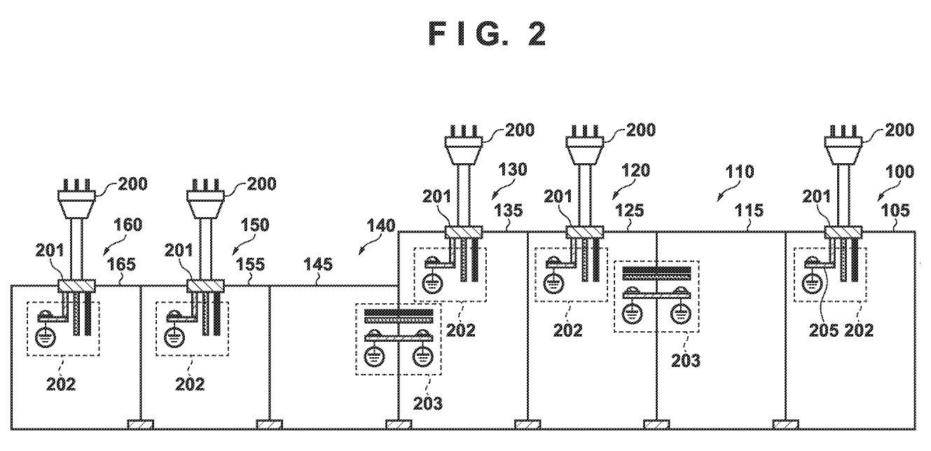

FIG. 2 is an explanatory view of a housing configuration and a power distribution path of the image forming apparatus 10. In the present embodiment, the feeding module 100 is provided in a feeding housing 105. The printing module 110 is provided in a printing housing 115. The drying module 120 is provided in a drying housing 125. The fixing module 130 is provided in a fixing housing 135. The cooling module 140 is provided in a cooling housing 145. The inverting module 150 is provided in an inverting housing 155. The stacking module 160 is provided in a stacking housing 165. As illustrated in FIG. 2, each of the seven modules of the present embodiment is provided in one housing, but one or more of the seven modules can be constituted by a plurality of housings. The plurality of housings constituting one module can be integrally connected before shipment and shipped in a connected state.

In the present embodiment, the feeding housing 105, the drying housing 125, the fixing housing 135, the inverting housing 155, and the stacking housing 165 are provided with an inlet 201 for connecting a power source cord 200. These housings are connected to an external alternating current power source via the power source cord 200 connected to the inlet 201. An inlet bundled line 202 is connected to the inlet 201. Note that it is possible to provide a configuration in which the inlet bundled line 202 and the power source cord 200 are not connected via the inlet 201 but the inlet bundled line 202 and the power source cord 200 are directly connected. That is, it is possible to provide a configuration in which the power source cord 200 is connected so as not to be removed from the housing.

On the other hand, in the present embodiment, the printing housing 115 and the drying housing 125 are not provided with the inlet 201. That is, the printing housing 115 and the drying housing 125 are configured not to be connected to the external power source via the power source cord 200. Instead, electric components constituting the printing module 110 stored in the printing housing 115 receive power supply via the drying housing 125. Similarly, electric components constituting the cooling module 140 stored in the cooling housing 145 receive power supply via the fixing housing 135. In order to supply power from the drying housing 125 to the printing housing 115, the drying housing 125 and the printing housing 115 are connected by an inter-housing bundled line 203. In order to supply power from the fixing housing 135 to the cooling housing 145, the fixing housing 135 and the cooling housing 145 are connected by the inter-housing bundled line 203.

Note that the image forming apparatus 10 of the present embodiment operates on a single-phase alternating current, and the power source cord 200 and the inlet bundled line 202 include two electric wires (hereinafter, an L wire and an N wire) for transmitting a single-phase alternating current and a protective ground wire 205. ‎ The protective ground wire 205 in the inlet bundled line 202 is connected to the housing provided with the inlet bundled line 202.

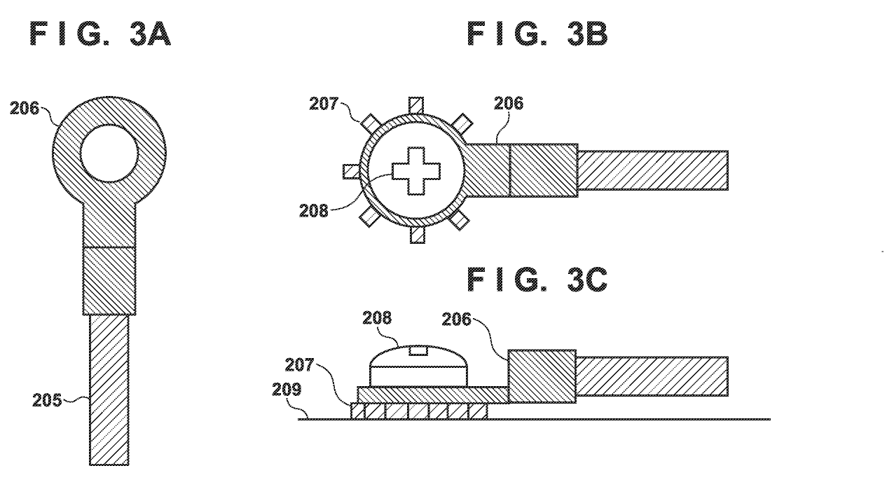

FIGS. 3A to 3C are explanatory views of connection of the protective ground wire 205 to the housing. As illustrated in FIG. 3A, the protective ground wire 205 has a round terminal 206 attached by caulking at an end portion thereof. The thickness of the protective ground wire 205 is selected according to the value of the flowing current. FIG. 3B is a plan view illustrating a state in which the protective ground wire 205 is connected to the housing, and FIG. 3C is a side view thereof. When the protective ground wire 205 is connected to a sheet metal 209 for protective ground connection provided in the housing, a serrated lock washer 207 for anti-loosening is sandwiched between the round terminal 206 and the sheet metal 209. Then, the round terminal 206 and the serrated lock washer 207 are connected to the sheet metal 209 by a screw 208. Connection of the protective ground wire 205 to the housing is performed so as to have a predetermined ground resistance value or less in a manufacturing process of the image forming apparatus 10. Note that depending on the configuration of the sheet metal 209, a washer may be used in place of the serrated lock washer 207.

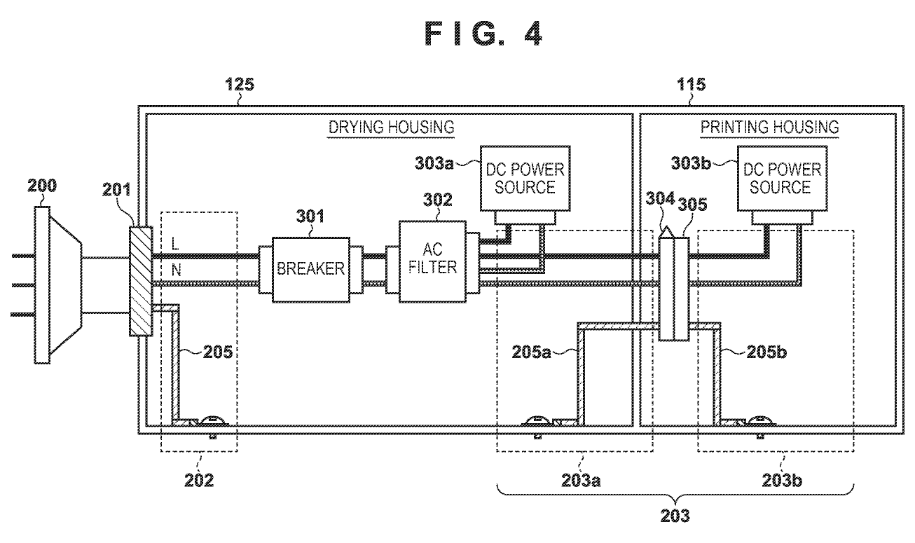

Next, connection between the housings will be described with reference to FIG. 4 with an example of connection between the drying housing 125 and the printing housing 115. In the drying housing 125, the L wire and the N wire of the inlet bundled line 202 are connected to an input L terminal and an input N terminal of a breaker 301. The protective ground wire 205 of the inlet bundled line 202 is connected to the drying housing 125 as described with reference to FIGS. 3A to 3C. An output L terminal and an output N terminal of the breaker 301 are connected to an input L terminal and an input N terminal of an AC filter 302. The AC filter 302 is provided to suppress a noise component from the external alternating current power source. An output L terminal and an output N terminal of the AC filter 302 are connected to an input L terminal and an output N terminal of a DC power source 303a. The DC power source 303a is a power source unit that performs alternating current/direct current conversion to supply operation power to the electric components of the drying module 120 stored in the drying housing 125.

The inter-housing bundled line 203 includes a dry-side bundled line 203a, a connector 304, a connector 305, and a print-side bundled line 203b. The connector 304 is a male connector having a pin-shaped connection terminal as an electric contact portion. The connector 305 is a female connector having a connection terminal for sandwiching a pin-shaped connection terminal of the connector 304 to secure electric connection. Note that in the present embodiment, the connector 304 is male and the connector 305 is female, but the connector 304 may be female and the connector 305 may be male.

One end portions of the L wire and the N wire of the dry-side bundled line 203a are connected to the output L terminal and the output N terminal of the AC filter 302. The other end portions of the L wire and the N wire of the dry-side bundled line 203a are connected to the connector 304. One end portion of a protective ground wire 205a of the dry-side bundled line 203a is connected to the drying housing 125 as described with reference to FIGS. 3A to 3C, and the other end portion is connected to the connector 304. One end portions of the L wire and the N wire of the print-side bundled line 203b are connected to the input L terminal and the input N terminal of a DC power source 303b, and the other end portions are connected to the connector 305. One end portion of a protective ground wire 205b of the print-side bundled line 203b is connected to the printing housing 115 as described with reference to FIGS. 3A to 3C, and the other end portion is connected to the connector 305. The DC power source 303b is a power source unit that performs alternating current/direct current conversion to supply operation power to the electric components of the printing module 110 stored in the printing housing 115.

As illustrated in FIG. 4, the connector 304 and the connector 305 are connected, whereby the L wire, the N wire, and the protective ground wire 205a of the dry-side bundled line 203a are connected to the L wire, the N wire, and the protective ground wire 205b of the print-side bundled line 203b. Hence, the alternating current voltage from the drying module 120 is applied to the DC power source 303b, and the printing housing 115 and the drying housing 125 are connected by the protective ground wires 205a and 205b. Note that as the connector 304 and the connector 305, those that can secure a creepage distance corresponding to basic insulation between terminals in the connector are used.

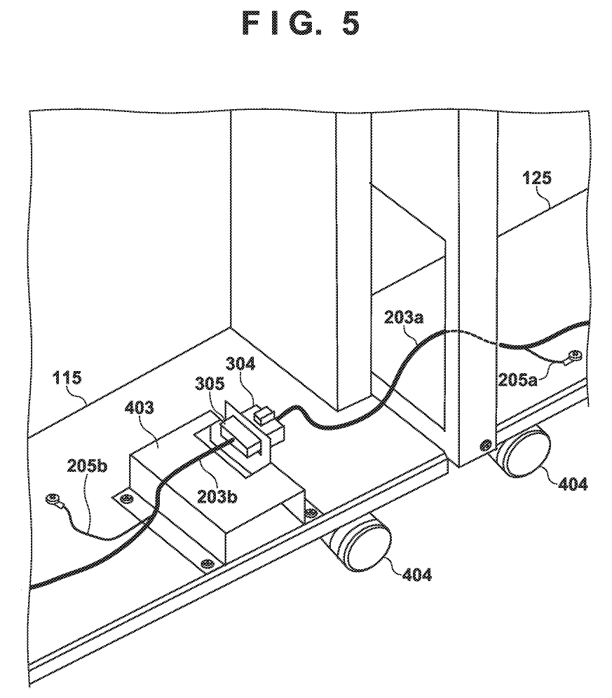

FIG. 5 is an explanatory view of connection processing for connecting the dry-side bundled line 203a and the print-side bundled line 203b. The connector 305 to be connected to the print-side bundled line 203b is fixed to a mount base 403 in the printing housing 115 at the time of manufacturing. The dry-side bundled line 203a and the connector 304 are accommodated in the drying housing 125 at the time of shipment. At the time of installation of the image forming apparatus 10, as illustrated in FIG. 5, the printing housing 115 and the drying housing 125 are arranged adjacent to each other. In the example of FIG. 5, the drying housing 125 and the printing housing 115 are provided with casters 404 for facilitating movement of the housing. After the printing housing 115 and the drying housing 125 are arranged adjacent to each other, the worker wires the dry-side bundled line 203a into the printing housing 115. Then, the worker connects the connector 304 to the connector 305.

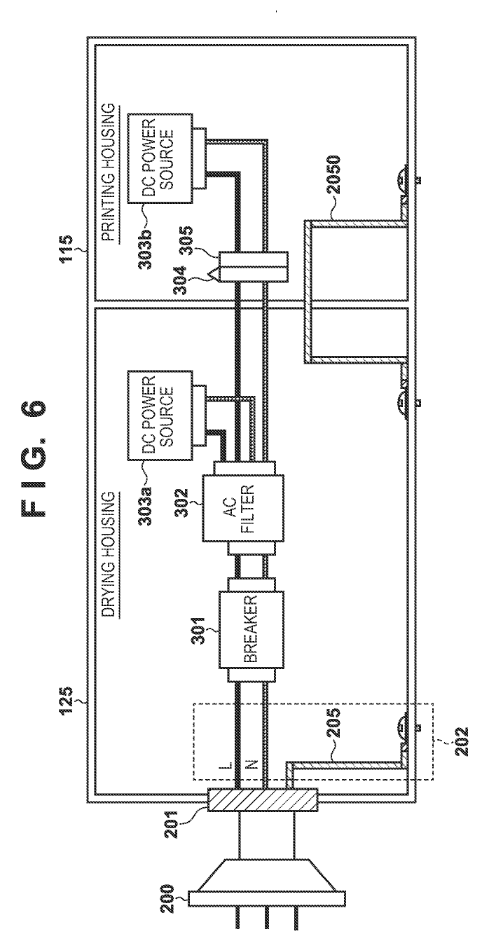

FIG. 6 illustrates a comparative configuration in which the drying housing 125 and the printing housing 115 are connected by the protective ground wire 205. According to FIG. 6, a protective ground wire 2050 connecting the drying housing 125 and the printing housing 115 is shipped in a state of being connected to only any one of the drying housing 125 and the printing housing 115. The connector 304 and the connector 305 are used only for connection of the L wire and the N wire.

Therefore, at the time of installation of the image forming apparatus 10, it is necessary to connect the protective ground wire 2050 to the unconnected housing among the drying housing 125 and the printing housing 115 in addition to the connection between the connector 304 and the connector 305. Here, in a case of the configuration of FIG. 6, when the connector 304 and the connector 305 are connected, the image forming apparatus 10 operates even if connection of the protective ground wire 2050 is not performed. Even if the work of connecting the protective ground wire 2050 to the unconnected housing among the drying housing 125 and the printing housing 115 is performed, there is a possibility that the protective ground wire 2050 is not appropriately connected to the housing.

In this manner, the connection between the two housings by the protective ground wire 2050 is performed at the time of installation of the apparatus. However, there can be a work-related error such as omission of connection work of the protective ground wire 2050 or failure in appropriate connection of the protective ground wire 2050 to the housing although the connection work has been performed. Even in such a case, since the apparatus itself operates normally, the apparatus can be operated with the protective ground wire 2050 not being properly connected.

On the other hand, in the present embodiment, shipment is performed in a state in which the protective ground wire 205a is connected to the drying housing 125 and the connector 304, and the protective ground wire 205b is connected to the printing housing 115 and the connector 305. Therefore, at the time of installation of the apparatus, the protective ground wires between the housings are connected by connector connection. It is possible to confirm presence/absence of connection of the protective ground by whether or not connection between the connector 304 and the connector 305 is performed. Hence, it is possible to promote appropriate connection between the housings by the protective ground wire.

As clear from FIG. 4, when the connector 304 and the connector 305 are not connected, no alternating current voltage is applied to the DC power source 303b of the printing housing 115, and the DC power source 303b does not operate. Therefore, the printing module 110 does not operate, and hence the image forming apparatus 10 also does not operate. In this manner, in order to operate the image forming apparatus 10, it is necessary to connect the connector 304 and the connector 305. By connecting the connector 304 and the connector 305, the housings are connected by the protective ground wire. Therefore, it is possible to promote appropriate connection between the housings by the protective ground wire. Furthermore, it is possible to suppress occurrence of a state in which the image forming apparatus 10 is operated in a state in which the protective ground between the housings is not connected.

Note that in the present embodiment, alternating current voltage is applied to the DC power source 303b of the printing housing 115 via the AC filter 302. However, alternating current voltage can be configured to be applied to the DC power source 303b via a terminal block or the like not via the AC filter 302. In this case, alternating current voltage can be configured to be applied to the DC power source 303b via an AC filter provided in the printing housing 115.

### Second Embodiment

Next, a difference between the second embodiment and the first embodiment will be described. The first embodiment is configured such that the protective ground wire connecting the housings is connected by connection between the connector 304 and the connector 305, and AC power is supplied from the drying housing 125 to the printing housing 115. In the present embodiment, AC power is supplied via a connector different from the connector for connecting the protective ground wire.

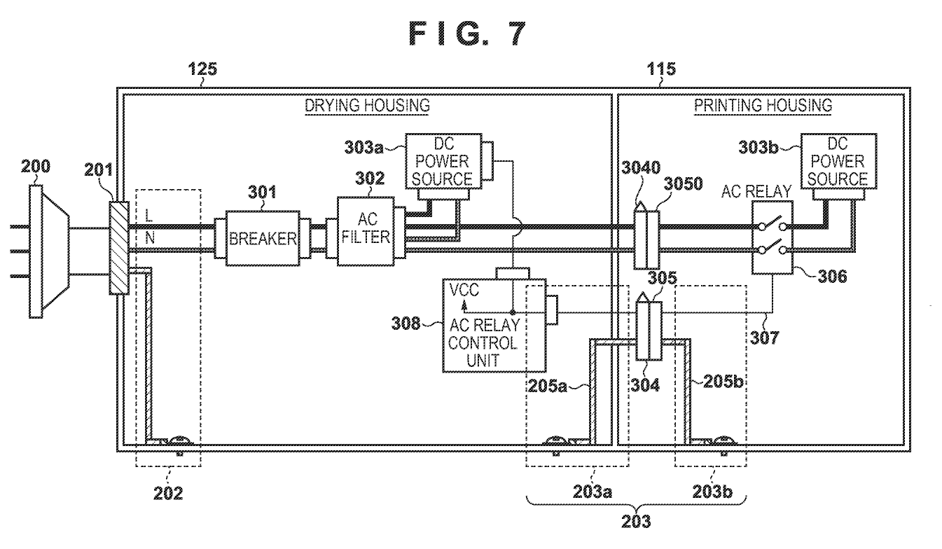

FIG. 7 illustrates a connection configuration between the drying housing 125 and the printing housing 115 according to the present embodiment. In the present embodiment, the drying housing 125 is provided with an AC relay control unit 308. The AC relay control unit 308 operates with DC power supplied from the DC power source 303a. The printing housing 115 is provided with an AC relay 306.

In the present embodiment, the dry-side bundled line 203a includes an electric wire (control line) for transmitting a control signal output by the AC relay control unit 308 and the protective ground wire 205a. The control line of the dry-side bundled line 203a is connected to an output terminal of a control signal by the AC relay control unit 308 and the connector 304. The protective ground wire 205a of the dry-side bundled line 203a is connected to the drying housing 125 and the connector 304 similarly to the first embodiment. The print-side bundled line 203b according to the present embodiment also includes a control line for transmitting a control signal output by the AC relay control unit 308 and the protective ground wire 205b. The control line of the print-side bundled line 203b is connected to an input terminal of a control signal to the AC relay 306 and the connector 305. The protective ground wire 205b of the print-side bundled line 203b is connected to the printing housing 115 and the connector 305 similarly to the first embodiment.

In the present embodiment, the output L terminal and the output N terminal of the AC filter 302 are connected to the input L terminal and the input N terminal of the DC power source 303b via connection of a connector 3040 and a connector 3050 and the AC relay 306. Note that an insulating distance corresponding to basic insulation is secured between a wire connecting the AC relay 306 from the AC filter 302 via the connection between the connector 3040 and the connector 3050 and a grounded portion, and an insulating distance corresponding to reinforced insulation is secured between the wire and an ungrounded portion.

Similarly to the first embodiment, by connecting the connector 304 and the connector 305, the drying housing 125 and the printing housing 115 are connected by the protective ground wire. By connecting the connector 304 and the connector 305, the AC relay 306 and the AC relay control unit 308 are connected by the control line. The AC relay 306 is an electric component settable to either a connected state in which the alternating current voltage from the AC filter 302 is applied to the DC power source 303b or a disconnected state in which the alternating current voltage from the AC filter 302 is not applied to the DC power source 303b. In the present embodiment, the AC relay 306 operates by receiving a control signal from the AC relay control unit 308 via the control line. More specifically, the AC relay 306 is configured to transition to the connected state when direct current voltage is applied from the AC relay control unit 308. On the other hand, the AC relay 306 is configured to transition to the disconnected state when no direct current voltage is applied from the AC relay control unit 308.

Therefore, in order to operate the DC power source 303b, it is necessary to operate the AC relay 306 by connecting the connector 304 and the connector 305 to set the AC relay 306 to the connected state. In this manner, also in the present embodiment, in order to operate the image forming apparatus 10, it is necessary to connect the connector 304 and the connector 305, and by connecting the connector 304 and the connector 305, the housings are connected by the protective ground wire. Therefore, it is possible to promote appropriate connection between the housings by the protective ground wire. Furthermore, it is possible to suppress occurrence of a state in which the image forming apparatus 10 is operated in a state in which the protective ground between the housings is not connected.

### Third Embodiment

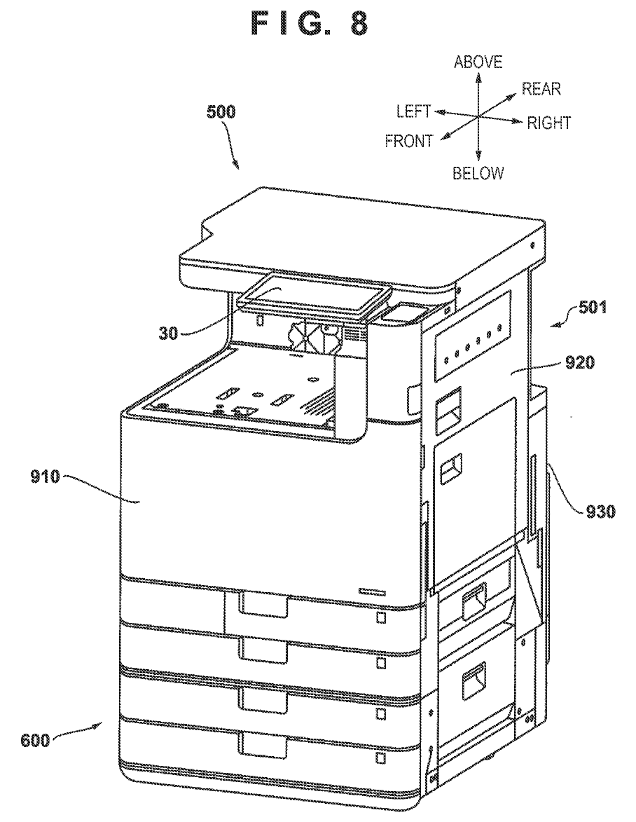

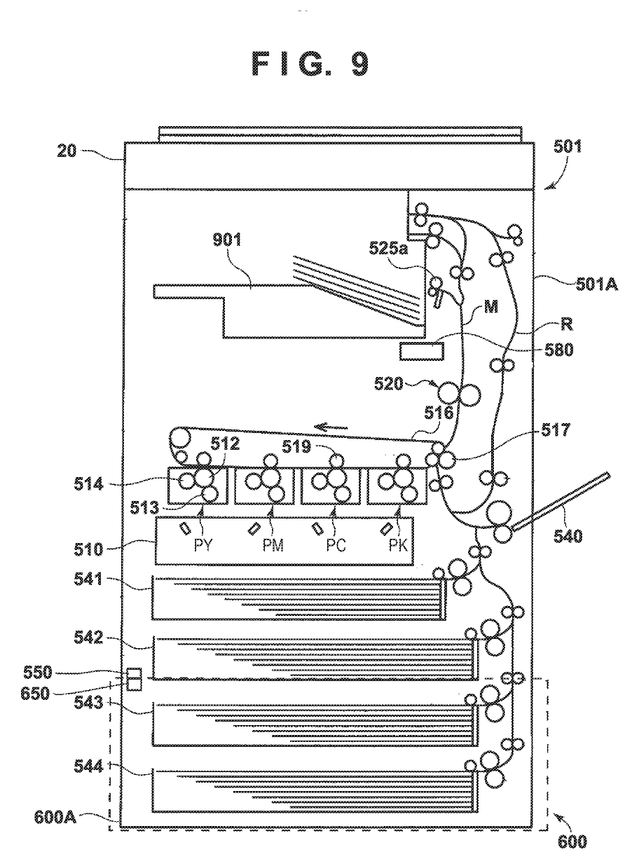

Next, the third embodiment will be described. FIG. 8 is a perspective view of an electrophotographic image forming apparatus 500 used for description of a third embodiment. An image forming apparatus 500 includes a main body unit 501 and a sheet storing portion 600. The main body unit 501 is stored in a housing 501A (FIG. 9), and the sheet storing portion 600 is stored in a housing 600A (FIG. 9). The main body unit 501 includes an operation unit 30 for the user to operate the image forming apparatus 500. In the following description, the side on which the user stands when operating the operation unit 30 is called a "front surface (front)", and the opposite side thereof is called a "back surface (rear)". The left side of the user who operates the operation unit 30 is called "left", and the right side is called "right". The front surface side of the housing 501A is provided with a front cover 910, both left and right side surfaces are provided with side covers 920, and the back surface is provided with a back cover 930. The housing 600A is arranged below the housing 501A.

FIG. 9 is a schematic cross-sectional view of the image forming apparatus 500. Image forming units PY, PM, PC, and PK of the main body unit 501 each include a photoconductor 512, a charger 513, a developer 514, and a primary transfer roller 519. The photoconductor 512 is rotationally driven in the clockwise direction in the drawing at the time of image formation. The charger 513 charges the photoconductor 512. A scanner unit 510 forms an electrostatic latent image on each of the photoconductors 512 by exposing each of the photoconductors 512. The developer 514 forms a toner image on the photoconductor 512 by developing the electrostatic latent image of the photoconductor 512 with toner. Note that the developers 514 of the image forming units PY, PM, PC, and PK develop the photoconductors 512 with toner of yellow, magenta, cyan, and black, respectively. Therefore, toner images of yellow, magenta, cyan, and black are formed on the photoconductors 512 of the image forming units PY, PM, PC, and PK, respectively. The primary transfer roller 519 transfers the toner image of each of the photoconductors 512 to an intermediate transfer body 516 to be rotationally driven in the anticlockwise direction in the drawing. The toner image transferred to the intermediate transfer body 516 is conveyed to an opposing position of a secondary transfer roller 517 by the rotation thereof.

The main body unit 501 includes cassettes 541 and 542 that store sheets, and a manual feed tray 540. The sheet storing portion 600 includes cassettes 543 and 544 that store sheets. The image forming apparatus 500 feeds a sheet from any of the cassettes 541 to 544 and the manual feed tray 540 to a main conveyance path M and conveys the sheet toward the opposing position of the secondary transfer roller 517. The secondary transfer roller 517 transfers the toner image of the intermediate transfer body 516 onto the sheet. A fixer 520 fixes the toner image to the sheet. In a case where an image is formed only on one surface of the sheet, after the toner image is fixed, the sheet is discharged to a discharge tray 901 by a discharge roller 525a. In a case where images are formed on both surfaces of the sheet, after the toner image is fixed, the sheet is conveyed to a both-surface conveyance path R and is conveyed again to the opposing position of the secondary transfer roller 517. The main conveyance path M is provided with a roller for feeding sheets of the cassettes 541 to 544 and the manual feed tray 540 to the main conveyance path M and a roller for conveying the sheets. The both-surface conveyance path R is provided with a roller for conveying the sheet.

A reading unit 20 of the main body unit 501 optically reads an image of a document. The image forming apparatus 500 can form an image based on image data of an image read by the reading unit 20 or based on image data received via a network.

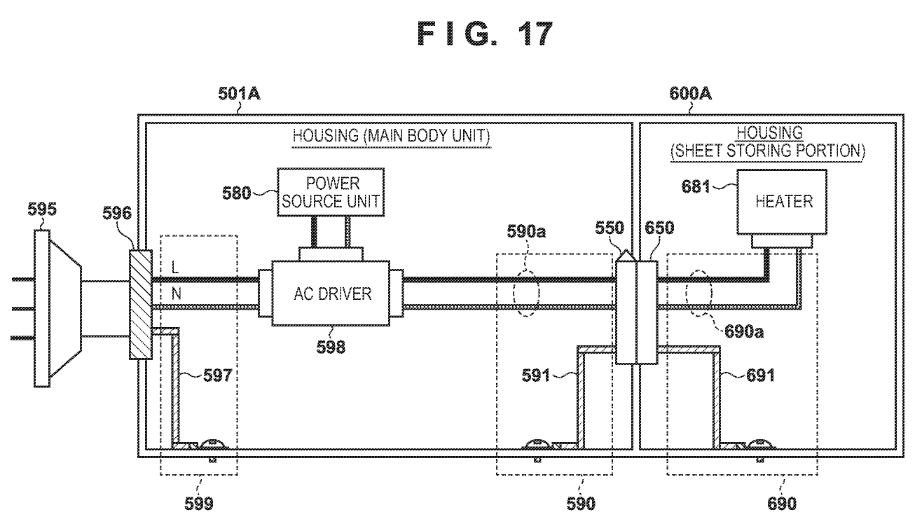

A power source unit 580 of the main body unit 501 is electrically connected to the external alternating current power source, and supplies operation power to electric components in the housing 501A. In the present embodiment, the cassettes 541 to 544 are provided with a heater 681 (FIG. 17) for dehumidifying the sheet. The heater 681 of the cassettes 543 and 544 is a heating unit that generates heat by the AC power received via the housing 501A under the control of a control unit not illustrated.

Therefore, the housing 600A is configured to be arranged under the housing 501A, to receive AC power from the housing 501A, and to transmit/receive a control signal to/from a control unit not illustrated in the housing 501A. Therefore, the housing 501A of the main body unit 501 is provided with a connector module 550, and the housing 600A of the sheet storing portion 600 is provided with a connector module 650. The image forming apparatus 500 of the present embodiment is configured such that the connector module 550 and the connector module 650 are connected by placing the housing 501A on the housing 600A.

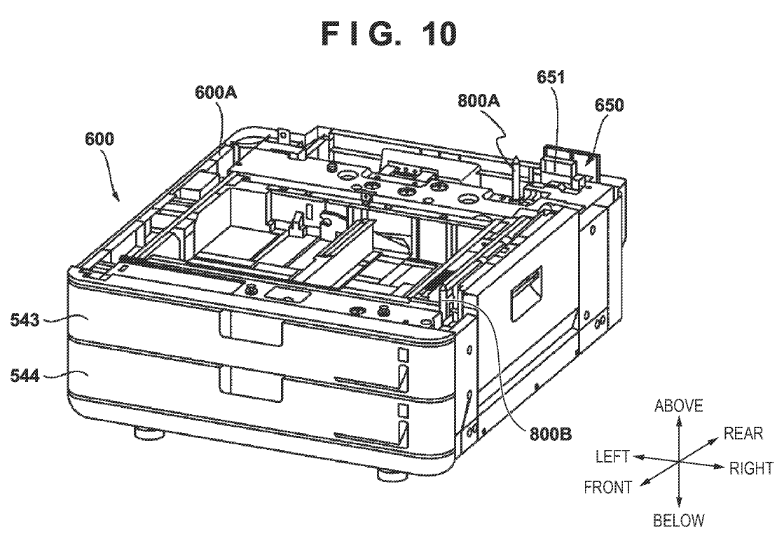

FIG. 10 is a perspective view of the sheet storing portion 600. The sheet storing portion 600 is provided with the connector module 650 to be connected to the connector module 550 of the main body unit 501. The connector module 650 includes a terminal portion 651. Furthermore, the sheet storing portion 600 is provided with positioning pins 800A and 800B. The positioning pins 800A and 800B are members to be fitted into positioning holes of the main body unit 501 when the housing 501A is arranged on the housing 600A. By fitting the positioning pins 800A and 800B into the positioning holes of the main body unit 501, the relative positional relationship between the housing 501A and the housing 600A is regulated to a predetermined positional relationship in which the housing 501A can be placed on the housing 600A.

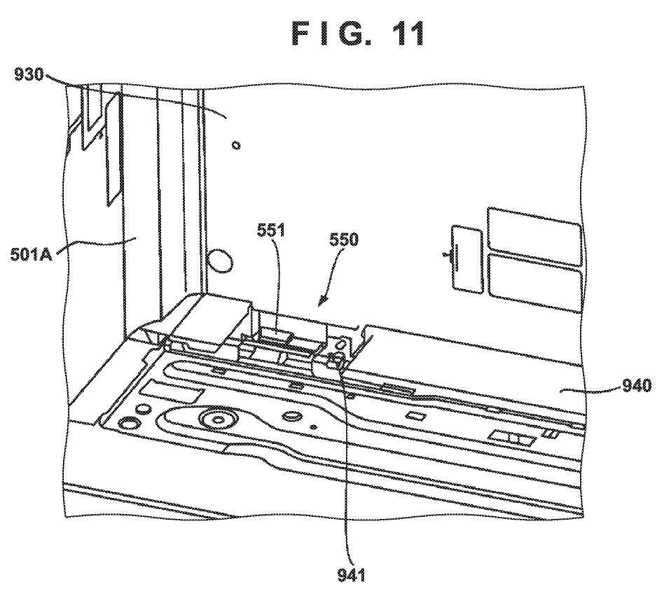

FIG. 11 is a perspective view of a bottom surface portion 940 of the housing 501A. The bottom surface portion 940 is provided with the connector module 550 to be connected to the connector module 650 of the sheet storing portion 600. The connector module 550 includes a terminal portion 551. The terminal portion 551 is provided so as to be exposed from an opening 941 provided in the housing 501A. Although not illustrated in FIG. 11, the bottom surface portion 940 is provided with positioning holes through which the positioning pins 800A and 800B of the housing 600A penetrate.

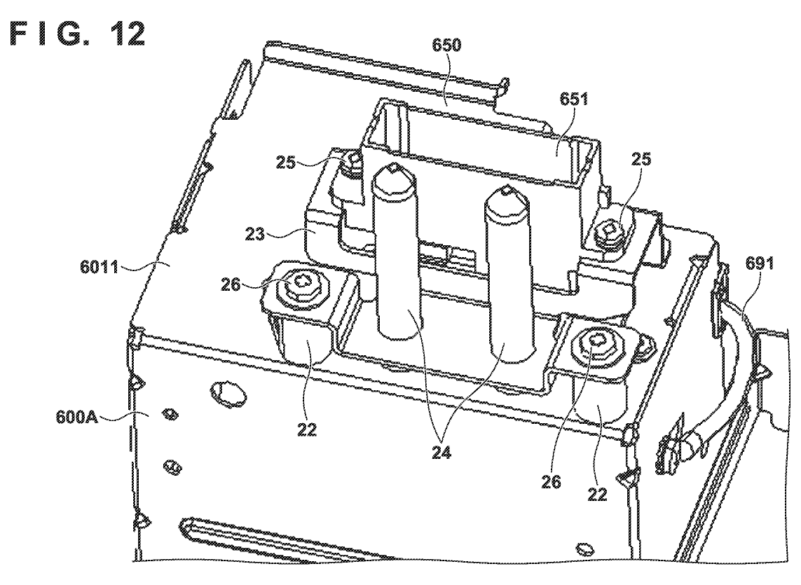

FIG. 12 is an enlarged view illustrating the vicinity of the connector module 650 of the sheet storing portion 600. The terminal portion 651 of the connector module 650 is electrically connected to the terminal portion 551 of the connector module 550 when the housing 501A is arranged above the housing 600A. The terminal portion 651 is fixed to a connector support portion 23 by two fixing screws 25. The connector support portion 23 is attached to the housing 600A by a plurality of stepped screws 26. A coil spring 22 is arranged between a head portion of the stepped screw 26 and the housing 600A. The coil spring 22 enables the connector support portion 23 to swing with respect to a mounting surface 6011 attached with the connector support portion 23 in the housing 600A, and biases the connector support portion 23 toward the connector module 550. The connector module 650 includes a guide pin 24 protruding upward. The guide pin 24 is provided to be insertable/removable into/from a guide hole 14a of the connector module 550. As illustrated in FIG. 12, one end portion of a protective ground wire 691 is connected to the housing 600A. Note that the other end portion of the protective ground wire 691 is connected to a terminal of the terminal portion 651.

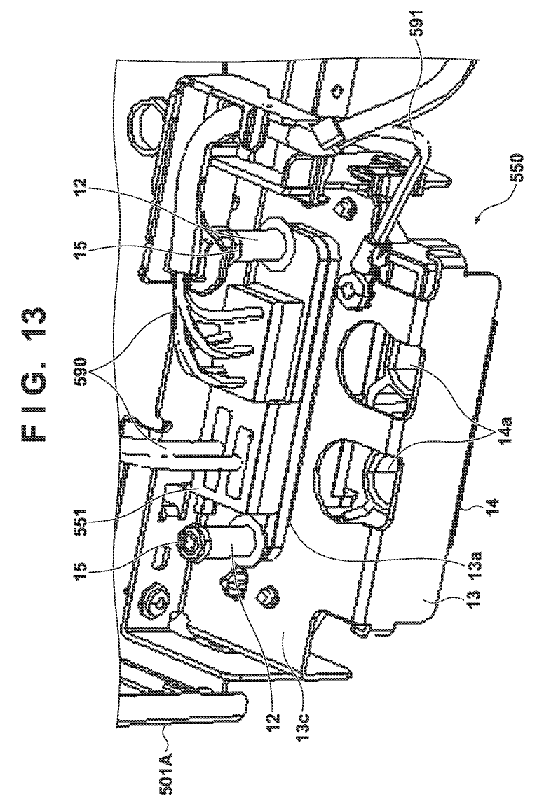

FIG. 13 is an enlarged view illustrating the vicinity of the connector module 550 of the main body unit 501. The terminal portion 551 of the connector module 550 is electrically connected to the terminal portion 651 of the connector module 650 when the housing 501A is arranged above the housing 600A. The terminal portion 551 is supported on a mounting surface 13c of a connector support portion 13 by a stepped screw 15 in a state in which a part thereof protrudes downward from an opening 13a formed in the connector support portion 13.

A coil spring 12 is arranged between a head portion of the stepped screw 15 and the connector support portion 13. The coil spring 12 biases the connector support portion 13 toward the housing 600A. The connector support portion 13 includes a guide portion 14 provided with the guide hole 14a. By arranging the housing 501A on the housing 600A such that the guide pin 24 of the connector module 650 penetrates the guide hole 14a, the relative positional relationship between the housing 501A and the housing 600A is regulated to a positional relationship in which the terminal portion 551 and the terminal portion 651 are connected. Note that as illustrated in FIG. 13, one end portion of a protective ground wire 591 is connected to the housing 501A. Note that the other end portion is connected to a terminal of the terminal portion 551. A cable 590 is connected to the terminal portion 551. The cable 590 stores an electric wire (the L wire and the N wire, and collectively called a power line hereinafter) for supplying AC power to the sheet storing portion 600, and an electric wire (control line) for conveying a control signal. ‎

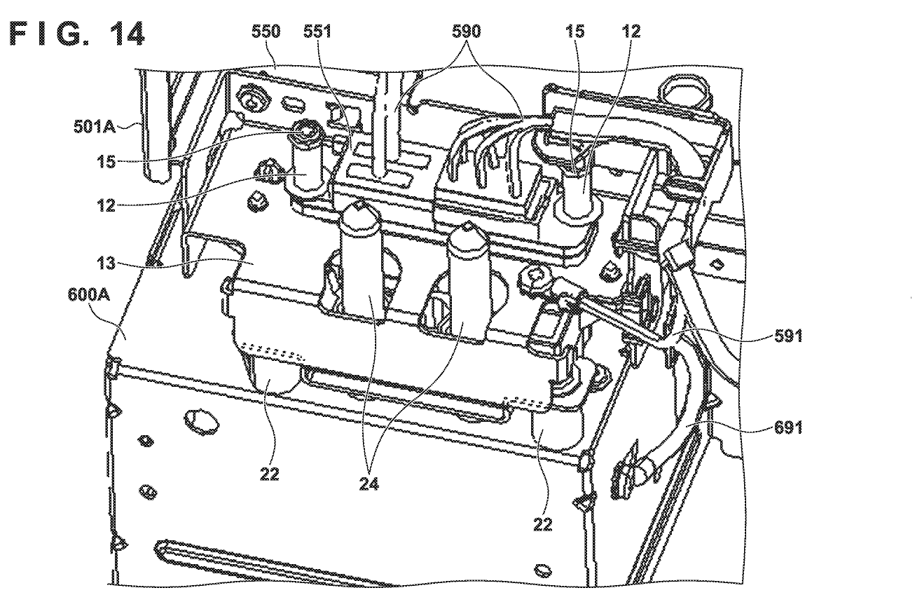

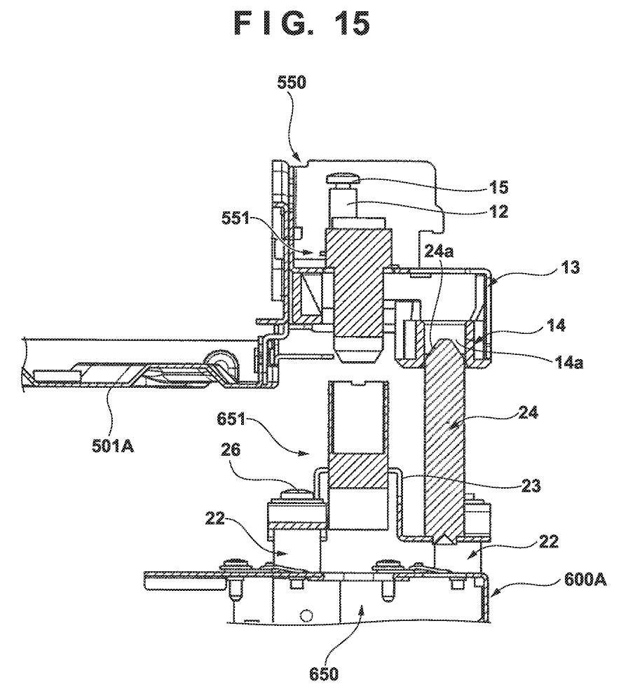

FIG. 14 is a perspective view illustrating a state in which the housing 501A is arranged on the housing 600A, and FIG. 15 is a cross-sectional view illustrating a time point at which the guide pin 24 starts to enter the guide hole 14a. As illustrated in FIG. 15, the connector module 550 and the connector module 650 are configured such that when the housing 501A is arranged on the housing 600A, a tip portion 24a of the guide pin 24 is inserted into the guide hole 14a before the terminal portion 551 is inserted into the terminal portion 651. The guide pin 24 is appropriately inserted into the guide hole 14a, whereby relative positioning of the terminal portion 551 and the terminal portion 651 is performed, and the terminal portion 551 is appropriately inserted into the terminal portion 651.

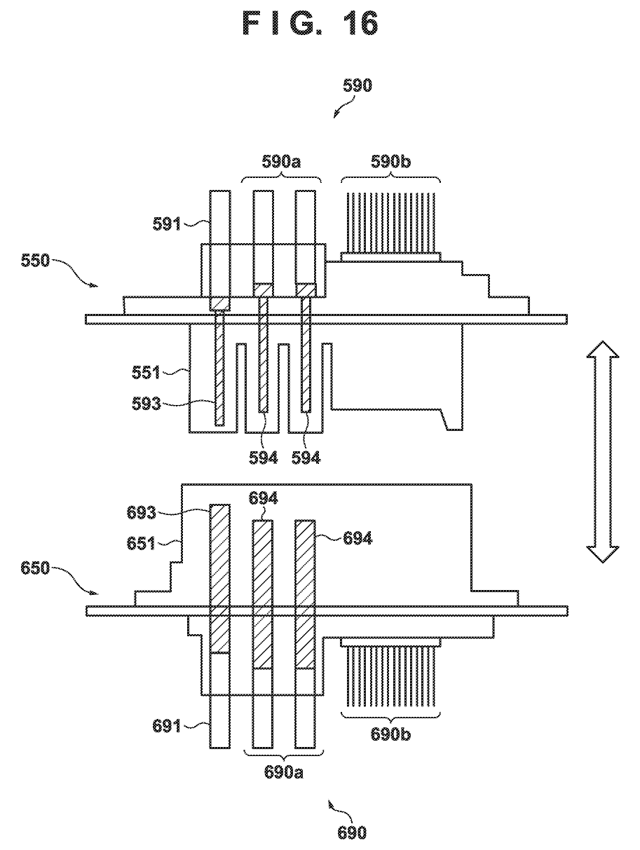

FIG. 16 is an explanatory view of a detailed configuration of the terminal portion 551 and the terminal portion 651. The cable 590 and the protective ground wire 591 are connected to the terminal portion 551, and a cable 690 and the protective ground wire 691 are connected to the terminal portion 651. The cable 590 includes a power line 590a and a control line 590b. The cable 690 includes a power line 690a and a control line 690b.

The protective ground wire 591 is connected to a contact 593 of a male type for power of the terminal portion 551, and the power line 590a is connected to a contact 594 of a male type for power of the terminal portion 551. The control line 590b is connected to a contact (not illustrated) of a male type for a signal of the terminal portion 551. The protective ground wire 691 is connected to a contact 693 of a female type for power of the terminal portion 651, and the power line 690a is connected to a contact 694 of a female type for power of the terminal portion 651. The control line 690b is connected to a contact (not illustrated) of a female type for a signal of the terminal portion 651. By the connector module 550 and the connector module 650 being fitted, the contact of the terminal portion 551 and the corresponding contact of the terminal portion 651 are electrically connected.

Note that in the present embodiment, the terminal portion 551 includes a male contact and the terminal portion 651 includes a female contact, but the terminal portion 551 may include a female contact and the terminal portion 651 may include a male contact.

The connector module 550 and the connector module 650 are configured to perform sequential connection. Specifically, when the terminal portion 551 and the terminal portion 651 are connected, the contact 593 to be connected to the protective ground wire 591 and the contact 693 to be connected to the protective ground wire 691 are first connected, and then the contact 594 and the contact 694 are connected. The connector module 550 and the connector module 650 are configured such that the contact to be connected to the control line 590b and the contact to be connected to the control line 690b are finally connected. Therefore, at the time of connection of the housing 501A and the housing 600A, the protective ground wires between the housings are first connected, the power line 590a and the power line 690a are then connected, and the control line 590b and the control line 690b are finally connected. When the housing 501A and the housing 600A are separated, the connection is disconnected in the reverse order to the time of connection. That is, the protective ground wires between the housings are finally disconnected. This conforms to safety standards when power distribution of AC power is performed between housings. Note that as the terminal portion 551, one that can secure a distance corresponding to basic insulation between the contacts is used. Similarly, as the terminal portion 651, one that can secure a creepage distance corresponding to basic insulation between the contacts is used.

FIG. 17 illustrates a state in which the housing 501A and the housing 600A are connected. Note that the control lines are omitted in FIG. 17. The housing 501A includes an inlet 596, and a power source cord 595 is connected to the inlet 596. An inlet bundled line 599 includes a protective ground wire 597, an L wire, and an N wire. One end portion of the protective ground wire 597 is connected to the ground terminal of the inlet 596, and the other end portion is connected to the housing 501A. One end portions of the L wire and the N wire of the inlet bundled line 599 are connected to an L terminal and an N terminal of the inlet 596, and the other end portions are connected to an input L terminal and an input N terminal of an AC driver 598. The AC driver 598 suppresses a noise component included in the external alternating current power source, and supplies AC power to the power source unit 580 provided in the housing 501A and the heater 681 provided in the housing 600A. Therefore, the AC driver 598 and the power source unit 580 are connected by the L wire and the N wire. The connector module 550 and the AC driver 598 are connected by the power line 590a including the L wire and the N wire. One end portion of the protective ground wire 591 is connected to the housing 501A, and the other end portion is connected to the connector module 550. The connector module 650 and the heater 681 are connected by the power line 690a including the L wire and the N wire. One end portion of the protective ground wire 691 is connected to the housing 600A, and the other end portion is connected to the connector module 650.

As described above, shipment is performed in a state in which the protective ground wire 591 is connected to the housing 501A and the connector module 550 and the protective ground wire 691 is connected to the housing 600A and the connector module 650. Note that the connector module 550 is fixed to a side of the housing 501A that contacts the housing 600A, specifically, a lower side. The connector module 650 is fixed to a side of the housing 600A that contacts the housing 501A, specifically, an upper side. Then, the image forming apparatus 500 is configured such that the connector module 550 and the connector module 650 are connected by arranging the housing 501A and the housing 600A adjacent to each other in a predetermined positional relationship. Therefore, at the time of installation of the apparatus, the protective ground wires between the housings are connected by arranging the housing 501A on the housing 600A in a correct positional relationship. Presence/absence of connection of the protective ground wire can be confirmed by whether or not the housing 501A is arranged on the housing 600A in the correct positional relationship. Therefore, it is possible to promote appropriate connection between the housings by the protective ground wire.

As clear from FIG. 17, when the connector module 550 and the connector module 650 are not connected, the heater 681 is applied with no alternating current voltage, and the heater 681 does not operate. Therefore, in order to operate the heater 681, which is an electric component stored in the housing 600A, it is necessary to connect the connector module 550 and the connector module 650. With this connection, the housing 600A and the housing 501A are connected by the protective ground. Therefore, it is possible to promote appropriate connection between the housings by the protective ground wire. Furthermore, it is possible to suppress occurrence of a state in which the image forming apparatus 500 is operated in a state in which the protective ground between the housings is not connected.

### Overview

Note that each of the embodiments has been described with an inkjet image forming apparatus and an electrophotographic image forming apparatus as examples. However, each of the embodiments described above can be applied to any apparatus including a first housing configured to be connectable to an external alternating current power source and a second housing that stores an electric component supplied with operation power from the first housing. The apparatus includes a first protective ground wire connected to a first connector and the first housing, and a second protective ground wire connected to a second connector connectable to the first connector and the second housing. Therefore, the first protective ground wire and the second protective ground wire are connected by connecting the first connector and the second connector. With this configuration, it is possible to promote appropriate connection between the housings by the protective ground wires. Note that the second housing can be configured not to include a power source cord for connection with the external alternating current power source, or not to be connectable with the power source cord.

The apparatus can be configured such that a first electric wire is connected to the first connector, a second electric wire is connected to the second connector, and the first electric wire and the second electric wire are connected by connecting the first connector and the second connector. At least one electric component of the second housing can be configured not to operate unless the first electric wire and the second electric wire are connected. With this configuration, it is possible to suppress occurrence of a state in which the apparatus is operated in a state in which the protective ground between the housings is not connected.

The electric component can be any electric component that operates when applied with alternating current voltage from the first housing by connection between the first electric wire and the second electric wire. For example, in the first embodiment, the first housing is the drying housing 125, the second housing is the printing housing 115, and the electric component is the DC power source 303b that converts alternating current voltage from the first housing into direct current voltage and supplies it to another electric component provided in the second housing. Furthermore, in the third embodiment, the first housing is the housing 501A, the second housing is the housing 600A, and the electric component is the heater 681 that generates heat based on the alternating current voltage applied via the first housing.

The electric component can be any electric component that operates based on a control signal received from the first housing via the connection between the first electric wire and the second electric wire or direct current voltage from the first housing. For example, in the second embodiment, the electric component is the AC relay 306 that operates by a control signal (direct current voltage) from the AC relay control unit 308 provided in the first housing. The AC relay 306 is set to either a connected state in which the alternating current voltage from the first housing is applied to the DC power source 303b, by the control signal, or a disconnected state in which the alternating current voltage is not applied.

Note that although the AC relay 306 of the second embodiment does not operate by the power from the DC power source 303b, the electric component may operate by being supplied with operation power from the DC power source 303b and receiving a control signal via the connection between the first electric wire and the second electric wire. Note that the electric component may operate by receiving AC power by a power line different from the first electric wire and the second electric wire and receiving a control signal via the connection between the first electric wire and the second electric wire. The electric component may operate only by receiving DC operation power via the connection between the first electric wire and the second electric wire.

The apparatus of each of the embodiments described above operates on single-phase alternating current, but the apparatus may operate on three-phase alternating current. Furthermore, in each of the embodiments described above, the first housing supplies operation power only to the electric components stored in one second housing. However, the first housing can be configured to supply operation power to the electric components stored in a plurality of the second housings. As an example, the first housing and one second housing of the plurality of second housings are connected by a protective ground wire and a power line. The plurality of second housings can be configured to be connected in series by the protective ground wire and the power line. As another example, the first housing and each of the plurality of second housings can be configured to be individually connected by the protective ground wire and the power line. Furthermore, the former configuration and the latter configuration can be configured to be combined.

Furthermore, according to the present disclosure, a method for using an apparatus including a first housing configured to be connectable to an external alternating current power source, and a second housing including an electric component to be supplied with operation power from the first housing is provided. The method includes connecting, to the first housing, a first protective ground wire connected to a first connector, and connecting, to the second housing, a second protective ground wire connected to a second connector connectable to the first connector in a manufacturing process, and connecting the first connector and the second connector at a place where the apparatus is used. Note that the first protective ground wire and the second protective ground wire are connected to the first connector and the second connector such that the first protective ground wire and the second protective ground wire are connected by connecting the first connector and the second connector.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-196045, filed November 8, 2024, which is hereby incorporated by reference herein in its entirety.

What is claimed is:

1. An apparatus comprising:
a first housing configured to be connected to an external alternating current power source;
a second housing including an electric component configured to be supplied with operation power from the first housing;
a first connector;
a first protective ground wire connected to the first connector and the first housing;
a second connector; and
a second protective ground wire connected to the second connector and the second housing, wherein
the first protective ground wire and the second protective ground wire are connected by connecting the first connector and the second connector.

2. The apparatus according to claim 1, wherein
a first electric wire is connected to the first connector,
a second electric wire is connected to the second connector,
the first electric wire and the second electric wire are connected by connecting the first connector and the second connector, and
the electric component operates when applied with alternating current voltage from the first housing by connection between the first electric wire and the second electric wire.

3. The apparatus according to claim 2, wherein the first connector and the second connector are configured such that the first protective ground wire and the second protective ground wire are connected before the first electric wire and the second electric wire are connected when the first connector and the second connector are connected.

4. The apparatus according to claim 2, wherein
the first electric wire is connected to a terminal to be applied with alternating current voltage from the external alternating current power source in the first housing, and
the second electric wire is connected to the electric component.

5. The apparatus according to claim 2, wherein the electric component is a power source unit that converts alternating current voltage from the first housing into direct current voltage and supplies the direct current voltage to another electric component provided in the second housing.

6. The apparatus according to claim 2, wherein the electric component is a heater.

7. The apparatus according to claim 1, wherein
a first electric wire is connected to the first connector,
a second electric wire is connected to the second connector,
the first electric wire and the second electric wire are connected by connecting the first connector and the second connector, and
the electric component operates when applied with direct current voltage from the first housing by connection between the first electric wire and the second electric wire.

8. The apparatus according to claim 1, wherein
a first electric wire is connected to the first connector,
a second electric wire is connected to the second connector,
the first electric wire and the second electric wire are connected by connecting the first connector and the second connector, and
the electric component operates by receiving a control signal from the first housing by connection between the first electric wire and the second electric wire.

9. The apparatus according to claim 8, wherein
the second housing includes a power source unit that converts alternating current voltage from the first housing into direct current voltage and supplies the direct current voltage to another electric component provided in the second housing,
the electric component is a relay settable to either a connected state in which alternating current voltage from the first housing is applied to the power source unit or a disconnected state in which alternating current voltage from the first housing is not applied to the power source unit, and
the relay is set to the connected state by receiving the control signal via the second electric wire.

10. The apparatus according to claim 9, wherein
the first electric wire is connected to a control unit that is provided in the first housing and controls a state of the relay, and
the second electric wire is connected to the relay.

11. The apparatus according to claim 1, wherein
a first electric wire is connected to the first connector,
a second electric wire is connected to the second connector,
the first electric wire and the second electric wire are connected by connecting the first connector and the second connector, and
the electric component does not operate unless the first electric wire and the second electric wire are connected.

12. The apparatus according to claim 1, wherein the second housing does not include a power source cord for connection with an external alternating current power source.

13. The apparatus according to claim 1, wherein the second housing is not provided with an inlet for connecting a power source cord.

14. The apparatus according to claim 1, wherein
the first housing and the second housing are arranged so as to be adjacent to each other in a predetermined relative positional relationship,
the first connector is fixed and provided on a side of the first housing that contacts the second housing,
the second connector is fixed and provided on a side of the second housing that contacts the first housing, and
the first connector and the second connector are connected by arranging the first housing and the second housing so as to be adjacent to each other in the predetermined relative positional relationship.

15. The apparatus according to claim 14, wherein one housing of the first housing and the second housing is arranged above another housing.

16. The apparatus according to claim 1, wherein the apparatus is an image forming apparatus that forms an image on a sheet.

17. The apparatus according to claim 1, wherein
the apparatus is an image forming apparatus that forms an image on a sheet,
the second housing includes an image forming unit that forms an image on a sheet, and
the first housing includes a heating unit that applies heat to a sheet on which the image is formed.

18. A method for manufacturing an apparatus including a first housing configured to be connected to an external alternating current power source, and a second housing including an electric component configured to be supplied with operation power from the first housing, the method comprising:
connecting, to the first housing, a first protective ground wire connected to a first connector;
connecting, to the second housing, a second protective ground wire connected to a second connector; and
connecting the first connector and the second connector at a place where the apparatus is used,
wherein the first protective ground wire and the second protective ground wire are connected by connecting the first connector and the second connector.
